(19) United States
(12) Patent Application Publication
(10) Pub. No.: US 2024/0046185 A1
(43) Pub. Date: Feb. 8, 2024

(54) MICROSERVICE RESPONSE TIME MANAGEMENT

(71) Applicant: International Business Machines Corporation, Armonk, NY (US)

(72) Inventors: Yi Shao, Xian (CN); Ning Zhang, Xian (CN); Lei Tian, Xian (CN); Na Zhao, Xian (CN); Rong Hong Wan, Xian (CN)

(21) Appl. No.: 17/817,072

(22) Filed: Aug. 3, 2022

(51) Int. Cl. G06Q 10/06; G06N 5/02

(52) U.S. Cl. CPC G06Q 10/0637; G06N 5/022

(57) ABSTRACT

Embodiments of the present invention provide computer-implemented methods, computer program products and computer systems. For example, embodiments of the present invention can, in response to receiving information, predict availability of respective services deployed in a cloud environment. Embodiments of the present invention can then calculate an elastic index based on the predicted availability of the respective services.

### BACKGROUND

The present invention relates generally to microservices, and more particularly to improving microservice response time.

Typically, a microservice architecture can arrange an application as a collection of loosely coupled services. In a microservices architecture, services are fine-grained, and the protocols are lightweight. The goal is that teams can bring their services to life independent of others. Loose coupling reduces all types of dependencies and the complexities of the respective services. Developers of microservices typically do not force updates on users. In this way, software development is enabled to grow faster. Communication requirements are reduced. These benefits come at a cost to maintaining the decoupling. Interfaces need to be designed carefully and treated as a public API. One technique that is used is having multiple interfaces on the same service, or multiple versions of the same service, to not disrupt existing users of the code.

### SUMMARY

According to an aspect of the present invention, there is provided a computer-implemented method. The computer implemented method comprises: in response to receiving information, predicting availability of respective services deployed in a cloud environment; and calculating an elastic index based on the predicted availability of the respective services.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps for improving microservice response time, in accordance with an embodiment of the present invention;

FIG. 3 is an example diagram of circuit breaker transition probabilities, in accordance with an embodiment of the present invention;

FIG. 4 is an example diagram of a topology map used to calculate elastic index, in accordance with an embodiment of the present invention;

FIG. 5 is an example diagram for calculating whether a service is down, in accordance with an embodiment of the present invention;

FIG. 6 is an example diagram that illustrates a method for calculating a current status and a predicted next status of a service, in accordance with an embodiment of the present invention;

FIG. 7 illustrates calculated microservice availabilities, in accordance with an embodiment of the present invention; and

FIG. 8 illustrates a graph used to calculate elastic index, in accordance with an embodiment of the present invention.

### DETAILED DESCRIPTION

Embodiments of the present invention recognize that it is common in cloud (e.g., multi, hybrid, etc.) environments that users are offered typically include a rich set of connections to remote data sources. External dependencies to these remote data sources add complications to the system which result stability issues and poor response time when adopting a microservice. Traditional solutions decouple internal and external services and monitor health states of those respective services. Embodiments of the present invention recognize problems with these traditional solutions. Specifically, embodiments of the present invention recognize the difficulty in identifying the status of remote services through heart-beat/up-time checks, that there is no way to establish topology in advance, and that no single topology map can fit into all scenarios. As such, embodiments of the present invention provide solutions to certain deficiencies of existing solutions by accounting for application configuration and deployment environments into consideration.

Embodiments of the present invention leverage circuit breaker design (e.g., a design pattern used to detect failures and encapsulates the logic of preventing a failure from constantly recurring, during maintenance, temporary external system failure, or unexpected system difficulties). Typically, a client or consumer of a service will still need to wait for a timeout before the circuit breaker is switched to OPEN after failures reach a certain threshold. In a cloud environment, the instability of remote services make dependent services thus unusable or, at the very least, error-prone. As such, embodiments of the present invention provide solutions for this instability that improve response time by predicting availability of remote services such that dependent services could benefit from potential failure alerts and improve response time through adjustment of timeout settings, as discussed in greater detail later in this Specification. In other words, embodiments of the present invention predict availability of remote services such that those dependent services do not have to wait until the circuit changes to an OPEN state. This ability to proactively adjust connection strategy thus helps to improve microservice response time.

Embodiments of the present invention provide certain advantages over traditional solutions. For example, while some solutions may offer models that detects states of microservices using stochastic probability, embodiments of the present invention recognize those solutions do not account for application configuration and deployment environment. As such, embodiments of the present invention provide certain computer-implemented methods, computer program products, and computer systems for training machine learning models used to predict remote service availability. More specifically, embodiments of the present invention: 1) collect and organize client-side monitoring data, service-side monitoring data, and application log into feature vectors, 2) handle imbalanced historical data; and train Clustering models based on features vectors from 1) and 2), and method of use the Clustering model to train Probability Graphic Model to predict the next circuit breaker status.

As mentioned above, embodiments of the present invention present solutions for preprocessing (i.e., handling imbalanced data that is the result of a service being up and running and responsive more than 99.9% of the time, thus it's likely to train overfitted models without pre-processing). By reorganizing data using key events, embodiments of the present invention is able to handle service maintenance, service operations like rolling updates which can be potential significant factors.

In yet another example, certain embodiments of the present invention provide a way to estimate availability of remote services before actual timeout happens thereby improving functionality of the system. Performing one or more methods of the present invention can improve microservice response time rather than waiting for a circuit breaker to be triggered and can offer debugging connectivity among microservices to be easier and predictable.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as microservice optimizer 180. In general, microservice optimizer 180 improves microservice response time. In this embodiment, microservice optimizer 180 improves microservice response time by providing dynamic timeout adjustment using elastic index calculated by circuit break status transition probability based on clustering probabilistic graphic models. For example, microservice optimizer 180 provides an elastic index to reflect availability of remote services before timeout happens. In some embodiments, microservice consumers could update their connection strategy and improve response time. In other embodiments microservice optimizer 180, having permissioned access, can automatically update microservice connection strategy to improve response time. Microservice optimizer 180 calculates the elastic index based on run-time topology using pre-trained machine learning models that determine availability of different types of components and/or services. More specifically, microservice optimizer 180 improves microservice response time by collecting and organizing client-side monitoring data, server-side monitoring data, and application log in product and deployment aware feature vectors, training machine learning models using those feature vectors and ensemble these models to build a final model for predicting availability of a given service. Microservice optimizer 180 can then calculate an elastic index using the above-trained machine learning models and run-time topology.

In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

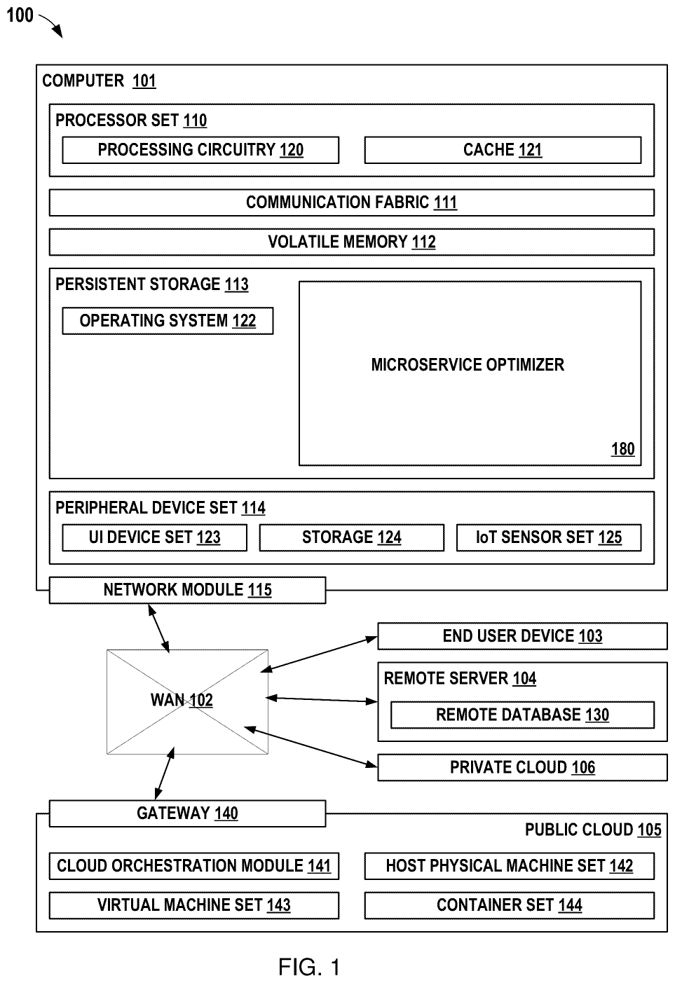

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

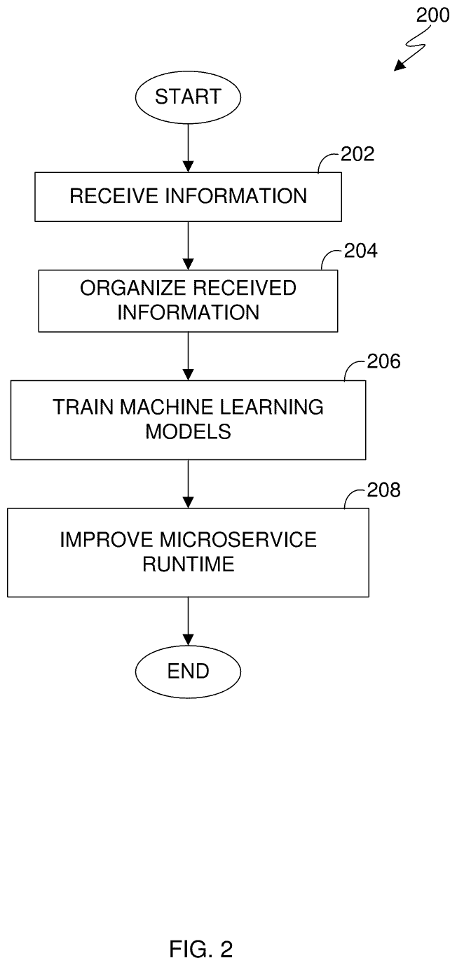

FIG. 2 is a flowchart 200 depicting operational steps for dynamically predicting a user need, in accordance with an embodiment of the present invention, in accordance with an embodiment of the present invention.

In step 202, microservice optimizer 180 receives information. In this embodiment, microservice optimizer 180 receives information from one or more databases. In other embodiments, microservice optimizer can receive information from one or more other components of computing environment 100. In this embodiment, “information” as used herein refers to data pertaining to one or more microservices. In particular, information includes client-side monitoring data, application logs for respective microservices, and service-side monitoring data. Client-side monitoring data includes request rate (crr), response time (crt), pagerduty warning alter from service (cpdaws), pagerduty warner alter from cluster/platform (cpdawp), pagerduty error alert from service (cpdaes), pagerduty error alter from cluster/platform (cpdaep), etc. Server-side monitoring data includes uptime data (sup), request rate (srr), response time (srt), etc. Application logs or product logs include endpoints of remote service to call (url), type of the call (ct, f.ex, synchronous=0, asynchronous=1), key event flag (kef, f.ex, success=0, failure=1). Information can also include circuit breaker status (e.g., cbs, close=0, half-open=1, open=2) and service monitoring statistics sms, depending on the nature of the service, different indexes can be monitored (e.g., f.ex, CPU, Memory, Disk I/O, Network, etc.)

In step 204, microservice optimizer 180 organizes the received information. In this embodiment, microservice optimizer 180 organizes the collected client-side monitoring data, server-side monitoring data, application log into product and deployment aware feature vectors by merging historical data, handling the imbalanced data, and organizing data into respective clusters following circuit breaker status.

Imbalanced data, as used herein, refers to data collected that is associated with a “success status” (i.e., functioning normally). Typically, microservice optimizer 180 recognizes that more than 99.9% of the time the service (also referred to as microservice) is up and running and responsive, thus most of the monitoring data collected are associated with success status which leads to imbalanced data. For example, for a closed state cluster (e.g., cbs=0, circuit breaker status is in closed state), there are more success events (e.g., kef=0) than failure events (kef=1). Similarly, in an open state, there are more failure events than success events. Microservice optimizer 180 handles imbalanced data by finding patterns triggered by circuit breaker status change and subsequently organizing data into respective clusters following circuit breaker status. For example, microservice optimizer 180 performs the following for each circuit breaker status change, that is, for each key event flag (kef) change, do the following for all data since last m ticks (m can be modified, a default of “3” is used in this embodiment): for time-series data, use moving average of the data, for continuous data, use mean of the data, for categorical data, use mode (i.e., the most frequently observed value in the data). Using this approach, microservice optimizer 180 does not need to differentiate service maintenance. Service operations like rolling update can be covered in srt so microservice optimizer 180 assumes the service should always be available.

In step 206, microservice optimizer 180 trains machine learning models using the above feature vectors and ensemble these models to build a final model for predicting remote service availability. In this embodiment, microservice optimizer 180 trains machine learning models by building a cluster model for circuit breaker status prediction and building an HMM model to predict circuit breaker status change. In this embodiment, microservice optimizer 180 builds a cluster model such that given statistics at any time, predict which circuit breaker status the service is most likely in. Microservice optimizer 180 trains a probability graphic model (e.g., f.ex, Bayesian Network, or Hidden Markov Model) such that given the current circuit breaker status, microservice optimizer 180 can predict the next circuit breaker status the service is going to be (i.e., find the transition probabilities (st_{!,#}, i, j∈0,1,2). In this embodiment, microservice optimizer 180 can train different probability graphic models (PGM) for each type of service (e.g., database, computing engine, containerized applications, etc.).

In step 208, microservice optimizer 180 improves microservice runtime. In this embodiment, microservice optimizer 180 improves microservice runtime by accessing client data logs, generating a run-time topology from service dependencies, calculating current circuit breaker status (e.g., probability or confidence) of each node, calculating next circuit breaker status of each node, calculating an elastic index at root node, and feeding elastic index back to the user and dependent application for timeout adjustment.

In this embodiment, microservice optimizer 180 generates a run-time topology from service dependencies by traversing context associated to different environments, data servers, associated physical and logical schemas containing data, and associated physical and logical agents to identify respective nodes and dependencies within the system. In this embodiment, microservice optimizer generates a new run-time topology different from existing monitoring strategies to identify alternative routes. Microservice optimizer 180 stores each identified independent route separately.

In this embodiment, microservice optimizer 180 calculates a current a next status of each dependents in the topology by transforming current data into key event and states, deciding which cluster the data should be mapped to, reorganizing data into time-ordered vector, calculating estimates and confidence of each individual models, and calculate the estimates to get a final prediction, along with the confidence scores. Microservice optimizer 180 can then follow the created topology map to calculate the elastic index at root node and subsequently update timeouts based on the calculated elastic index.

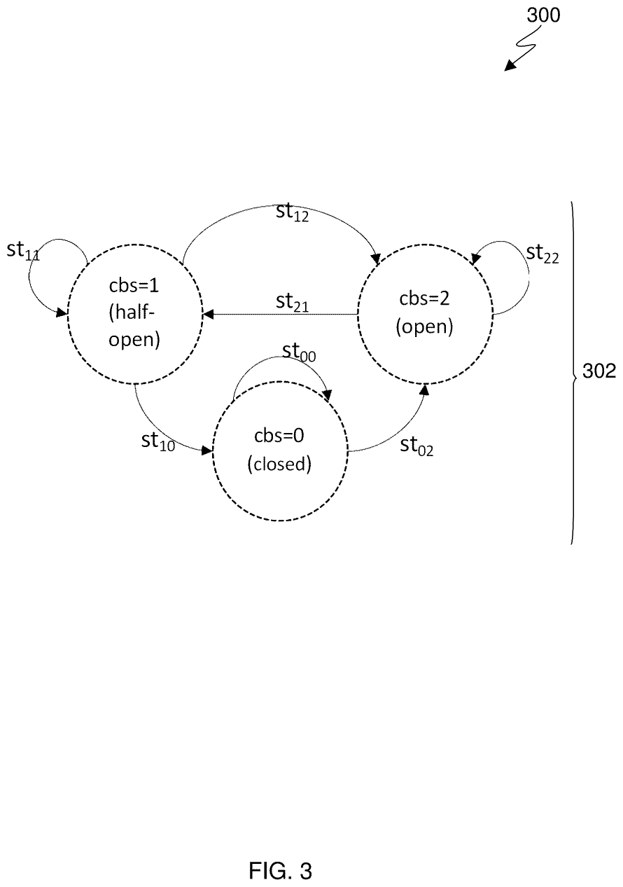

FIG. 3 is an example diagram 300 representing circuit breaker transition probabilities, in accordance with an embodiment of the present invention. Diagram 300 illustrates circuit breaker 302, respective circuit breaker status (e.g., open: cbs=2, half open: cbs=1, and closedcbs=0) and different transition probabilities (e.g., st₀₀, st₀₂, st₁₀, st₁₁, st₁₂, st₂₂, st₂₁, etc.)

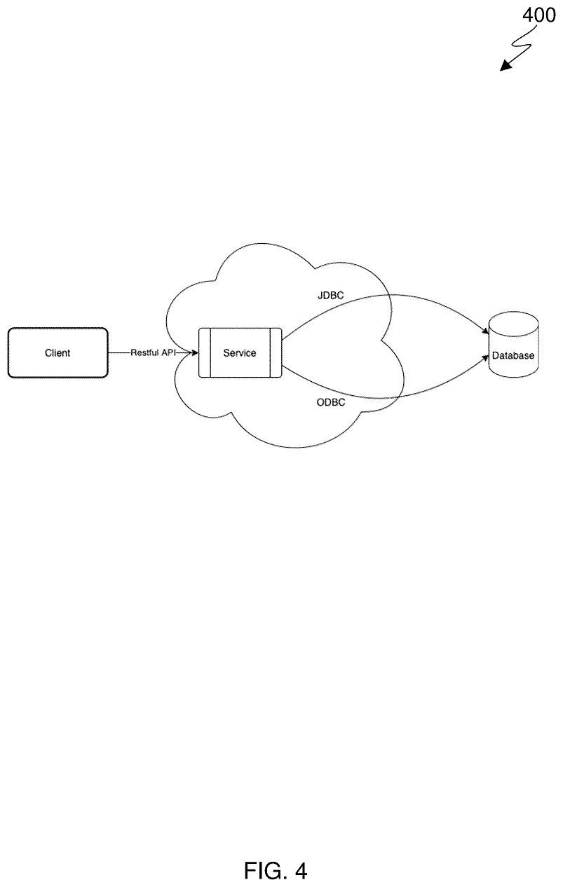

FIG. 4 is an example diagram of a topology map 400 used to calculate elastic index, in accordance with an embodiment of the present invention. In this example, microservice optimizer 180 generates topology map 400 that depicts respective services (e.g., a database) being accessed. In this example, the client accesses a service hosted in a network via a restful API. Microservice optimizer 180 has then mapped that particular service as accessing a database and that there are two connections (i.e., pathways) to accessing that database (e.g., java database connectivity (JDBC) or an open database connectivity (ODBC)). In other embodiments, different protocols other than JDBC/ODBC can be used to access the database.

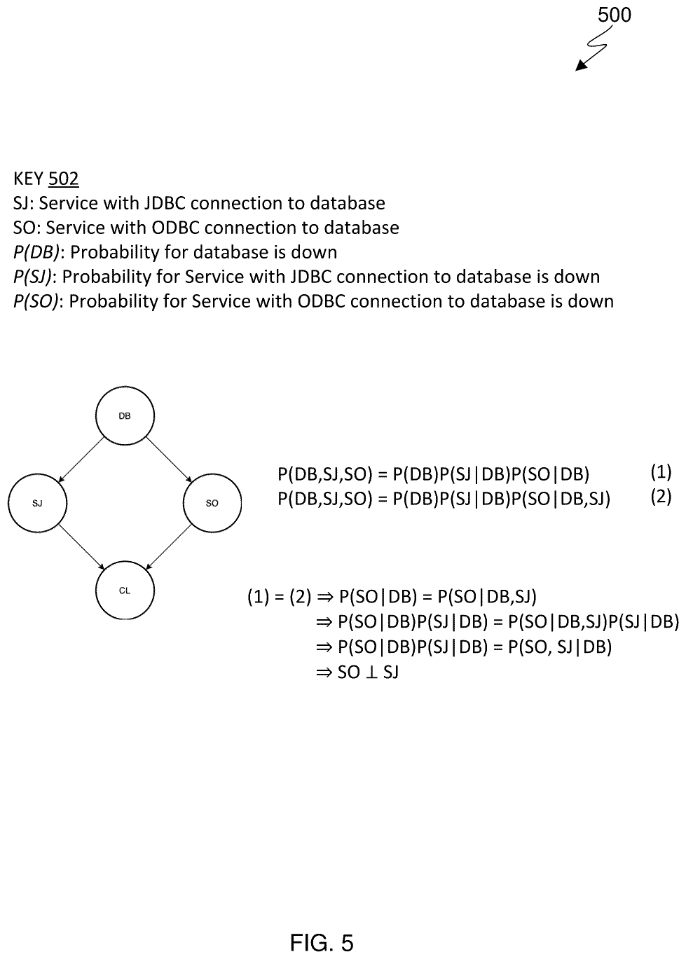

FIG. 5 is an example diagram 500 for calculating whether a service is down, in accordance with an embodiment of the present invention.

In this example, microservice optimizer 180 uses topology map 400 and key 502 to identify two services denoted SJ (e.g., service with JDBC connection to the database) and SO (e.g., service with ODBC connection to the database). In this example, microservice optimizer 180 generates probabilities for the database being down (e.g., P(DB)), the service with JDBC connection to the database being down (e.g., P(SJ)), and the service with ODBC connection to the database being down.

In this example, microservice can use the following two equations (e.g., equations 1 and 2 respectively) to calculate the probabilities mentioned above.

P(DB,SJ,SO)=P(DB)P(SJ|DB)P(SO|DB) (1)

P(DB,SJ,SO)=P(DB)P(SJ|DB)P(SO|DB,SJ (2)

(1)=(2)⇒P(SO|DB)=P(SO|DB,SJ)⇒P(SO|DB)P(SJ|DB)=P(SO|DB,SJ)P(SJ|DB)⇒P(SO|DB)P(SJ|DB)=P(SO,SJ|DB)⇒SO⊥SJ

Equations 1 and 2 represent two possible ways of calculating joint probability for a database being down, service with JDBC connection to database is down, and service with ODBC connection to database is down, based on the collected data. SO⊥SJ means that two events are independent with each other. In other words, microservice optimizer 180 cannot conclude service with ODBC connection to database is down simply because service with JDBC connection to the database is down which is why microservice optimizer 180 identifies alternative routes from the generated a run-time topology from service dependencies.

Continuing the above example, the service using JDBC is independent of the same service using ODBC. Microservice optimizer 180 thus needs to separate the service instance into two and calculate circuit breaker status accordingly.

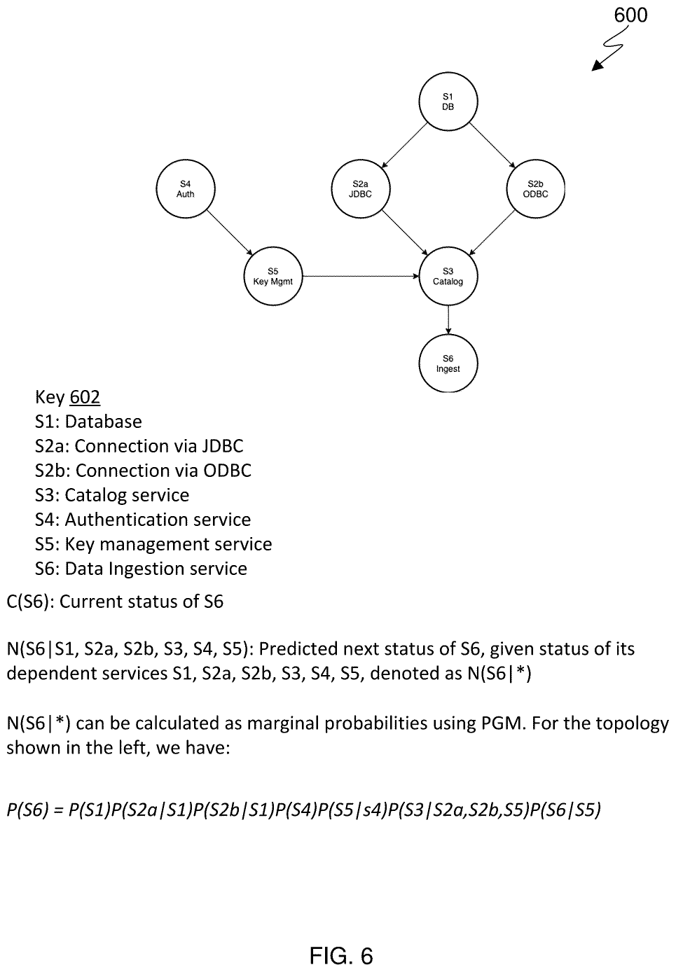

FIG. 6 is an example diagram 600 that illustrates a method for calculating a current status and a predicted next status of a service, in accordance with an embodiment of the present invention.

Diagram 600 represents a generated runtime topology of a service and includes one or more nodes labeled by Key 602. Specifically, diagram 600 includes S1 (a database), S2a (a connection via JDBC, S2b (a connection via ODBC), S3 (a catalog service), S4 (an authentication service, S5 (a key management service), and S6 (a data ingestion service). In this example, microservice optimizer 180 is tasked with generating current status of S6, denoted by C(S6) and previously described in step 206 of FIG. 2 (e.g., a regular clustering model where features vectors are used as input and column “cbs” is used as target to train the model) and the next status of S6 denoted as N(S6). In this example, microservice optimizer 180 uses equation 3 to calculate the next status of S6:

N(S6|S1,S2a,S2b,S3,S4,S5) (3)

where S6 denotes a current status of S6.

The predicted next status of S6, given the status of its dependent services, given status of its dependent services S1, S2a, S2b, S3, S4, S5 is denoted as N(S6|*). The star (*) in N(S6|*) denotes all dependent services based on the topology. N(S6) and N(S6|*) are the same, N(S6) can be considered as the shorthand form of N(S6|*).

N(S6|*) can be calculated as marginal probabilities using PGM. For the topology shown in the left, we have Equation 4

P(S6)=P(S1)P(S2a|S1)P(S2b|S1)P(S4)P(S5|s4)P(S3|S2a,S2b,S5)P(S6|S5) (4)

In this embodiment, P(S6) represents the probability for each state a service S6 will be. Take Bayesian Network as an example, a trained Bayesian Network model could give probabilities for all possible values of the target variable. The value with the highest probability will be the predicted value. For this example, the model could calculate P(S6 is in open state), P(S6 is in closed state), and P(S6 is in half-open state), the three probability values sum to 1, the state with the highest probability will be the next possible state of S6.

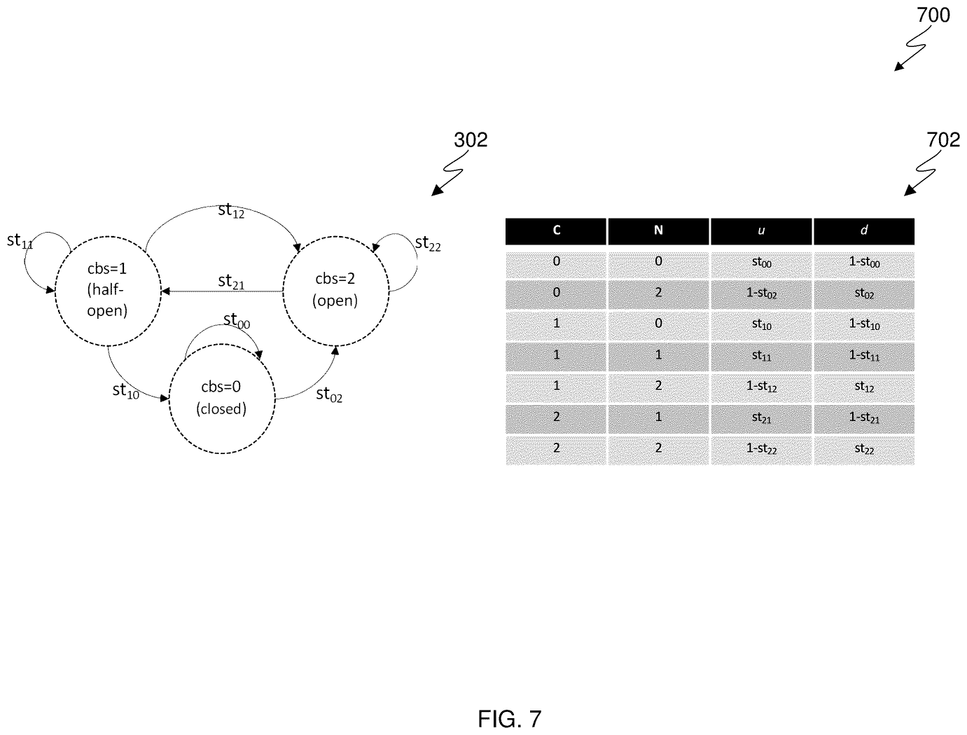

FIG. 7 illustrates calculated microservice availabilities, in accordance with an embodiment of the present invention.

FIG. 7 depicts circuit breaker 302 and corresponding table 702. Table 702 includes values C and N to decide microservice availability and use u to denote probability for when a microservice is running and use d to denote the probability when a microservice is done. Based on probabilities of each status, we can derive availability in the form of u and d accordingly.

As mentioned in FIG. 6, microservice optimizer 180 calculates “C” and “N” while the values for “u” and “d” are derived from P(S6) using table 702. For example, suppose current state of S6 is “closed” (C=0), predicted next state of S6 is “open” (N=2), and associated probability P(S6 is in open state)=0.8 (given by the model mentioned in paragraph [0054]. According to table 702, d=st02=0.8, u=1−st02=0.2.

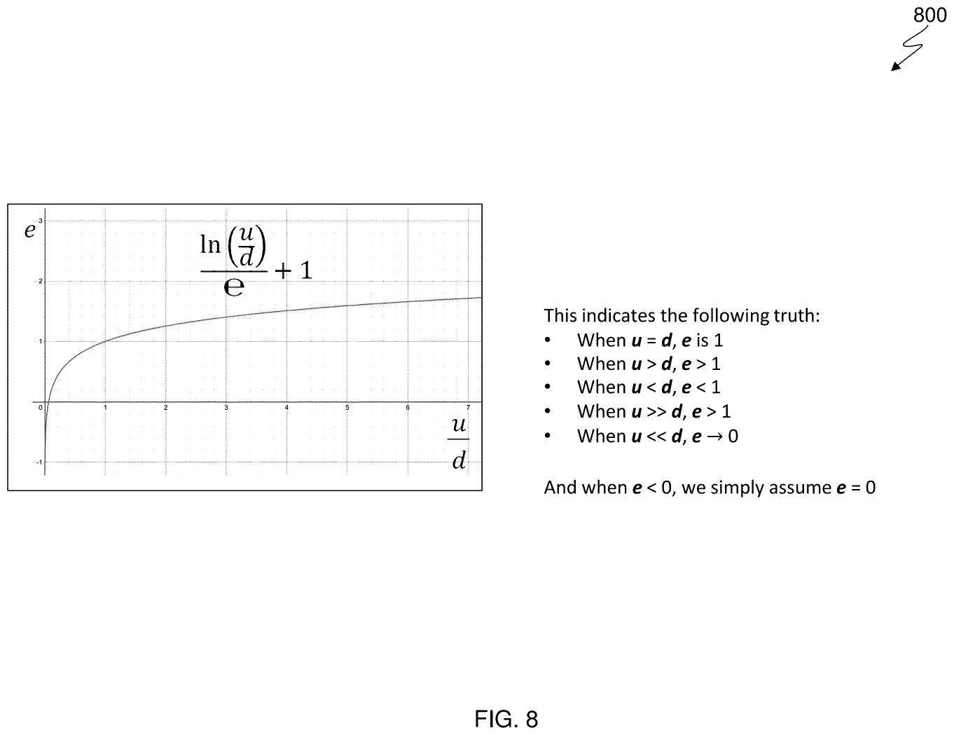

FIG. 8 illustrates a graph used to calculate elastic index, in accordance with an embodiment of the present invention.

Graph 800 leverages the values depicted on table 702. Given u and d, microservice optimizer 180 can calculate elastic index (e) using the following equation, equation 5:

$$\frac{ln ( \frac{u}{d} )}{e} + 1 \qquad ( 5 )$$

where when u=d, e is 1
when u>d, e>1
when u<d, e<1
when u>>d, e>1
when u<<d, e→0, and
And when e<0, we simply assume e=0

In this embodiment, the elastic index “e” represents threshold values that serve as suggestions or advice with respect to what extent a client could adjust its waiting time for this specific microservice. For example, e=1 means no change needed, e>1 suggests increasing waiting time, e<1 suggests decreasing waiting time, e=0 suggests treating the microservice as down, hence no need to wait for the timeout (i.e., direct the request to access a different service).

Accordingly, microservice optimizer 180 can then feed this elastic index back to the user and dependent application for timeout adjustment. In this embodiment, microservice optimizer 180 can automatically adjust timeouts for respective services which improves microservice response time rather than waiting for the circuit breaker to be trigger. In this way, microservice optimizer 180 estimate the availability of remote services before actual timeout happens, thereby improving microservice response and minimize downtime experienced by the system.

What is claimed is:

1. A computer-implemented method comprising:
in response to receiving information, predicting availability of respective services deployed in a cloud environment; and
calculating an elastic index based on the predicted availability of the respective services.

2. The computer-implemented method of claim 1, further comprising:
improving response time of respective services deployed in the cloud environment.

3. The computer-implemented method of claim 2, wherein improving response time of respective services deployed in the cloud environment comprises:
adjusting timeouts of the respective services based on the calculated elastic index, wherein adjusting timeouts of respective services based on the calculated index comprises:
in response to the calculated elastic index exceeding a value of one, increasing service wait time associated with a microservice of the respective services;
in response to the calculated elastic index being less than the value of one, decreasing wait time associated with the microservice of the respective services; and
in response to the calculated elastic index equaling a value of zero, identifying the microservice of the respective services as being down.

4. The computer-implemented method of claim 1, wherein predicting availability of respective services deployed in a cloud environment comprises:
merging historical data associated with the received information;
handling imbalanced data associated with the received information; and
organizing data associated with the received information into clusters based on circuit breaker status.

5. The computer-implemented method of claim 4, further comprising:
building a cluster model that predicts a current status for respective circuit breakers connected to respective services deployed in the cloud environment; and
building a Hidden Markov model (HMM) model that predicts status changes for the respective circuit breakers connected to the respective services deployed in the cloud environment.

6. The computer-implemented method of claim 5, wherein building a cluster model that predicts a current status for respective circuit breakers connected to respective services deployed in the cloud environment comprises:
generating a run-time topology from dependencies of services in the cloud environment;
transforming current data associated with each service into key event and states; and
determining which cluster the transformed data is mapped to.

7. The computer-implemented method of claim, 6 further comprising:
predicting respective current circuit breaker status for each service using the cluster model; and
predicting respective next circuit breaker status using the built HMM model.

8. A computer program product comprising:
one or more computer readable storage media and program instructions stored on the one or more computer readable storage media, the program instructions comprising:
program instructions to, in response to receiving information, predict availability of respective services deployed in a cloud environment; and
program instructions to calculate an elastic index based on the predicted availability of the respective services.

9. The computer program product of claim 8, wherein the program instructions stored on the one or more computer readable storage media further comprise:
program instructions to improving response time of respective services deployed in the cloud environment.

10. The computer program product of claim 9, wherein the program instructions to improve response time of respective services deployed in the cloud environment comprise:
program instructions to adjust timeouts of the respective services based on the calculated elastic index, wherein the program instructions to adjust timeouts of respective services based on the calculated index comprise:
program instructions to, in response to the calculated elastic index exceeding a value of one, increase service wait time associated with a microservice of the respective services;
program instructions to, in response to the calculated elastic index being less than the value of one, decrease wait time associated with the microservice of the respective services; and
program instructions to, in response to the calculated elastic index equaling a value of zero, identify the microservice of the respective services as being down.

11. The computer program product of claim 8, wherein the program instructions to predict availability of respective services deployed in a cloud environment comprise:
program instructions to merge historical data associated with the received information;
program instructions to handle imbalanced data associated with the received information; and
program instructions to organize data associated with the received information into clusters based on circuit breaker status.

12. The computer program product of claim 11, wherein the program instructions stored on the one or more computer readable storage media further comprise:
program instructions to build a cluster model that predicts a current status for respective circuit breakers connected to respective services deployed in the cloud environment; and
program instructions to build a Hidden Markov model (HMM) model that predicts status changes for the respective circuit breakers connected to the respective services deployed in the cloud environment.

13. The computer program product of claim 12, wherein the program instructions to build a cluster model that predicts a current status for respective circuit breakers connected to respective services deployed in the cloud environment comprise:
program instructions to generating a run-time topology from dependencies of services in the cloud environment;
program instructions to transform current data associated with each service into key event and states; and
program instructions to determine which cluster the transformed data is mapped to.

14. The computer program product of claim, 13 wherein the program instructions stored on the one or more computer readable storage media further comprise:
program instructions to predict respective current circuit breaker status for each service using the cluster model; and
program instructions to predict respective next circuit breaker status using the built HMM model.

15. A computer system comprising:
one or more computer processors;
one or more computer readable storage media; and
program instructions stored on the one or more computer readable storage media for execution by at least one of the one or more computer processors, the program instructions comprising:
program instructions to, in response to receiving information, predict availability of respective services deployed in a cloud environment; and
program instructions to calculate an elastic index based on the predicted availability of the respective services.

16. The computer system of claim 15, wherein the program instructions stored on the one or more computer readable storage media further comprise:
program instructions to improving response time of respective services deployed in the cloud environment.

17. The computer system of claim 16, wherein the program instructions to improve response time of respective services deployed in the cloud environment comprise:
program instructions to adjust timeouts of the respective services based on the calculated elastic index, wherein the program instructions to adjust timeouts of respective services based on the calculated index comprise:
program instructions to, in response to the calculated elastic index exceeding a value of one, increase service wait time associated with a microservice of the respective services;
program instructions to, in response to the calculated elastic index being less than the value of one, decrease wait time associated with the microservice of the respective services; and
program instructions to, in response to the calculated elastic index equaling a value of zero, identify the microservice of the respective services as being down.

18. The computer system of claim 15, wherein the program instructions to predict availability of respective services deployed in a cloud environment comprise:
program instructions to merge historical data associated with the received information;
program instructions to handle imbalanced data associated with the received information; and
program instructions to organize data associated with the received information into clusters based on circuit breaker status.

19. The computer system of claim 18, wherein the program instructions stored on the one or more computer readable storage media further comprise:
program instructions to build a cluster model that predicts a current status for respective circuit breakers connected to respective services deployed in the cloud environment; and
program instructions to build a Hidden Markov model (HMM) model that predicts status changes for the respective circuit breakers connected to the respective services deployed in the cloud environment.

20. The computer system of claim 19, wherein the program instructions to build a cluster model that predicts a current status for respective circuit breakers connected to respective services deployed in the cloud environment comprise:
program instructions to generating a run-time topology from dependencies of services in the cloud environment;
program instructions to transform current data associated with each service into key event and states; and
program instructions to determine which cluster the transformed data is mapped to.
